(19) United States
(12) Patent Application Publication
(10) Pub. No.: US 2016/0297039 A1
(43) Pub. Date: Oct. 13, 2016

(54) METHOD OF REMANUFACTURING AN ENGINE BLOCK

(71) Applicant: Caterpillar Inc., Peoria, IL (US)

(72) Inventors: Trent Simpson, Peoria, IL (US); Adam Ostein, Corinth, MS (US); Jarrod Moss, Thomasville, GA (US); Curtis Graham, Peoria, IL (US); Bharat Meduru, Dunlap, IL (US); Robert Sharp, Corinth, MS (US)

(73) Assignee: Caterpillar Inc., Peoria, IL (US)

(21) Appl. No.: 14/682,178

(22) Filed: Apr. 9, 2015

(51) Int. Cl. B23P 6/02; F02F 7/00

(52) U.S. Cl. CPC B23P 6/02; F02F 7/0002

(57) ABSTRACT

A method is provided for remanufacturing an engine block. The engine block includes a top deck and a passageway that opens at the top deck, and is partially defined in the engine block by a counterbore having a side surface and a base surface. The method includes spraying solid powder metal onto the side surface and the base surface by a gas dynamic cold spray method so as to form a fill member adhered with the side surface and the base surface.

### TECHNICAL FIELD

This disclosure relates to remanufacturing machine components, and in particular, to remanufacturing engine blocks.

### BACKGROUND

Engines are used in many types of machines, including those with applications in the construction, oil and gas, mining, power generation, and marine industries. Engines typically include an engine block having one or more cylinders, and a cylinder head that is mounted to the engine block. The cylinder head closes the cylinders, and often includes the structure for introducing a mixture of air and fuel into a combustion chamber portion of the cylinders. A piston is situated within each cylinder and is connected to a crankshaft. The pistons reciprocate in response to combustion events in the combustion chambers, thereby collectively rotating the crankshaft. Rotation of the crankshaft, in turn, may be used to power the machine, such as to propel it along or to operate one of its implements.

The field of remanufacturing machine components has greatly expanded in recent years, thereby extending the useful life of the components and conserving resources. For example, engine components have been remanufactured, including engine blocks. Over time and with use, features of an engine block may become worn or eroded, such as those near the interface between the engine block and the cylinder head. Remanufacturing techniques seek to address this wear or erosion, and restore the engine block to an improved condition.

For example, worn or eroded features of an engine block may be machined away, and then a metal insert may be press-fit into the engine block at that location to restore the engine block to its original shape. However, because of thermal expansion and contraction during operation, minor spaces between the inserts and the engine block may occur.

In addition, U.S. Patent Application Publication 2011/0138596A1 relates to repairing members of a diesel engine that have been damaged by wear, such as a crankcase or a cylinder head. The '596 publication discloses using thermal spraying techniques, such as arc wire spraying, to build up a worn portion of a member with a spray of melted metal. However, thermal spraying techniques can only be used to build up minor thicknesses of metal, as thicker applications are susceptible to cracking.

Therefore, a need exists for improvements relating to remanufacturing engine blocks.

### SUMMARY OF THE INVENTION

According to one aspect of this disclosure, a method is provided for remanufacturing an engine block having a top deck and a passageway that opens at the top deck. The passageway is partially defined in the engine block by a counterbore having a side surface that extends downwardly from the top deck and a base surface that extends inwardly from the side surface below the top deck. The method includes spraying solid powder metal onto the side surface and the base surface by a gas dynamic cold spray method so as to form a fill member adhered with the side surface and the base surface.

According to another aspect of this disclosure, a method is provided for remanufacturing an engine block having a top deck and a cylinder that opens at the top deck. The cylinder is partially defined by a counterbore having a side surface that extends downwardly from the top deck and a base surface that extends inwardly from the side surface below the top deck. The method includes inserting a mask member into the cylinder, spraying solid powder metal onto the side surface and the base surface by a gas dynamic cold spray method so as to form a fill member between the engine block and the mask member, and removing the mask member.

According to yet another aspect of this disclosure, a remanufactured engine block includes a body including a top deck, the body being formed of engine block material, a passageway that opens at the top deck, and a fill member including accumulated solid powder metal deposited onto the body by a gas dynamic cold spray method. The passageway is at least partially defined by the body and the fill member.

### BRIEF DESCRIPTION OF THE DRAWINGS

FIG. 1 is an isometric view showing an engine block.

FIG. 1A is an enlarged view showing a portion of the engine block of FIG. 1, including a cylinder, coolant passageways, mounting bores, and a lubricant passageway.

FIG. 2 is a cross section view taken along line 2-2 of FIG. 1A and showing features of a coolant passageway.

FIG. 3 is a cross section view like FIG. 2, but with the coolant passageway being partially defined by a counterbore.

FIG. 4 is a cross section view like FIG. 3, but with solid powder metal having been sprayed to adhere to the inner surface and base surface of the counterbore, and to form a fill member.

FIG. 5 is a cross section view like FIG. 4, but showing a portion of the fill member extending above the top deck of the engine block.

FIG. 6 is a cross section view like FIG. 5, but with the fill member machined to bring its upper surface into alignment with the top deck, and to define a remanufactured passageway.

FIG. 7 is a cross section view like FIG. 6, but with a surface treatment applied to the fill member, and with the fill member being machine so that the surface treatment generally aligns with the top deck and the wall surface of the passageway.

FIG. 8 is a cross section view taken along line 8-8 of FIG. 1A and showing features of a cylinder.

FIG. 9 is a cross section view like FIG. 8, but with the cylinder being partially defined by a counterbore.

FIG. 10 is a cross section view like FIG. 9, but with solid powder metal having been sprayed to adhere to the inner surface and base surface of the counterbore, and to form a fill member.

FIG. 11 is a cross section view like FIG. 10, but showing a portion of the fill member extending above the top deck of the engine block.

FIG. 12 is a cross section view like FIG. 11, but with the fill member machined to bring its upper surface into alignment with the top deck, and to define a remanufactured passageway.

FIG. 13 is a cross section view like FIG. 12, but with a surface treatment applied to the fill member, and with the fill member being machine so that the surface treatment generally aligns with the top deck and the wall surface of the passageway.

FIG. 14 is an isometric view like FIG. 1, but showing the engine block after being remanufactured.

FIG. 14A is an enlarged view like FIG. 1A, and showing the engine block after being remanufactured.

### DETAILED DESCRIPTION

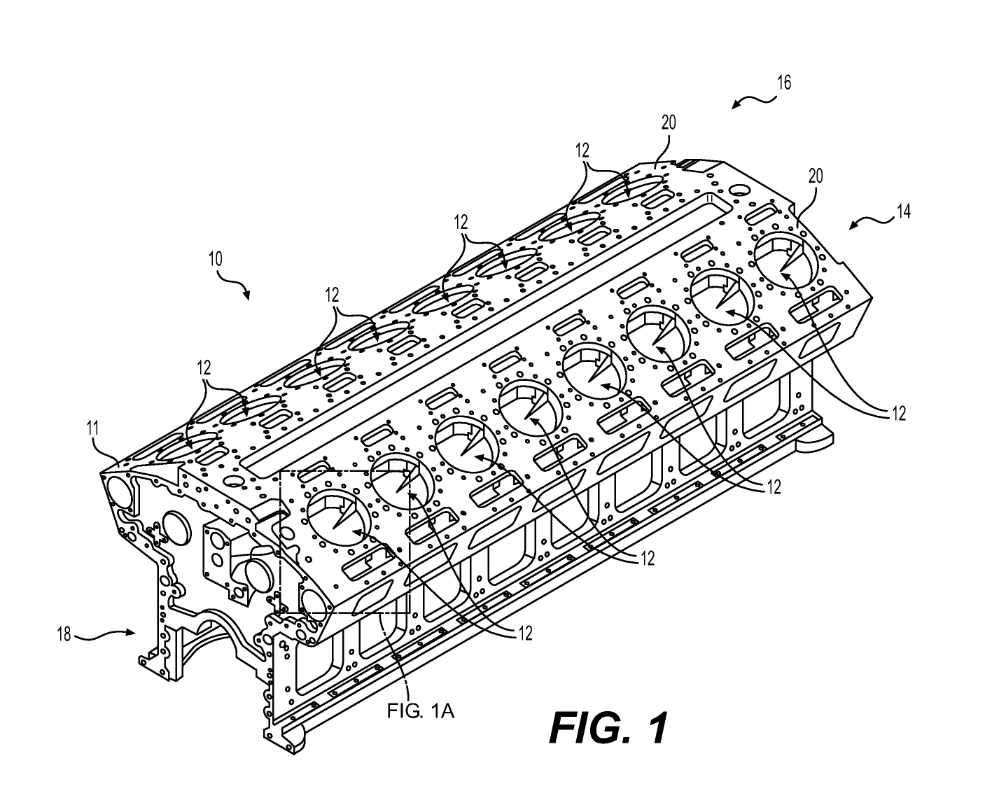

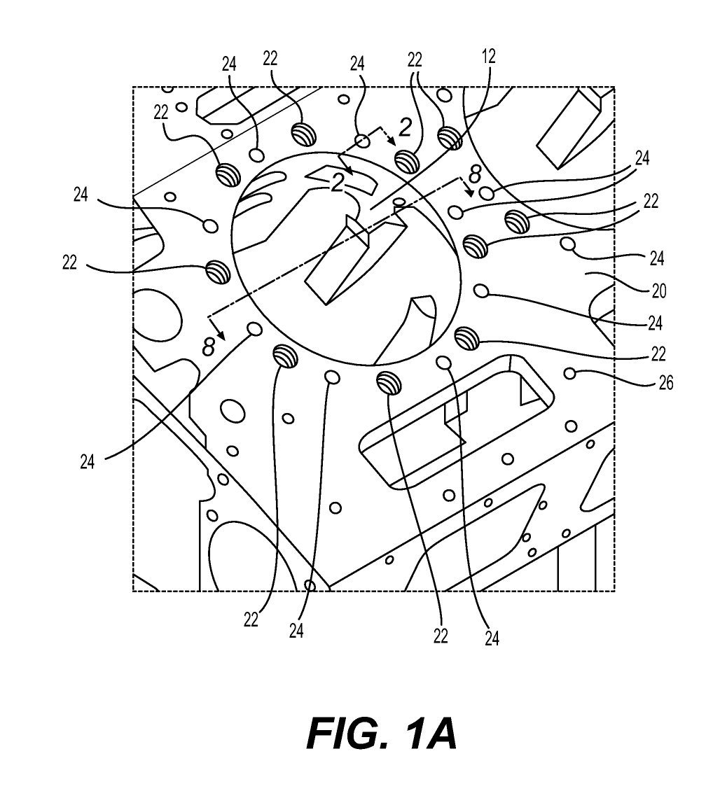

Referring to the figures, and beginning with FIG. 1, an exemplary engine block 10 is shown. Methods for remanufacturing the engine block 10 will be described below, following a description of some of its structural features.

The engine block 10 generally includes a body 11 formed of engine block material. The engine block 10 includes a plurality of cylinders 12, each of which is configured to receive a piston (not shown). For example, and in the embodiment shown, the engine block 10 includes a total of sixteen cylinders 12, divided into two cylinder banks: a first cylinder bank 14 having eight cylinders 12, and a second cylinder bank 16 also having eight cylinders 12. The two cylinder banks 14, 16 and their respective cylinders 12 are arranged in a “V” configuration. The engine block 10 also includes a crankcase 18 positioned generally below the two cylinder banks 14, 16. The crankcase 18 is configured to house a crankshaft (not shown) that is turned by pistons reciprocating in the cylinders 12.

The engine block 10 is configured to be attached with one or more cylinder heads (not shown). In particular, each cylinder bank 14, 16 of the engine block 10 includes a top deck 20, and the cylinders 12 open at the top decks 20. The cylinder heads may be configured to be attached to the top decks 20. For example, one or more cylinder heads may be attached to the top deck 20 of the cylinder bank 14, and one or more cylinder heads may be attached to the top deck 20 of the cylinder bank 16.

Referring next to the enlarged view of FIG. 1A, mounting bores 22 may be formed in the engine block 10 for receiving fasteners (not shown) for attaching a cylinder head to the engine block 10. For example, several mounting bores 22 may surround each cylinder 12 and open at the top deck 20, such as to a receive a bolt for attaching a cylinder head to the engine block 10.

The engine block 10 also includes passageways for coolant and lubricant. For example, several coolant passageways 24 may surround each cylinder 12 and open at the top deck 20, such as to align with related coolant passageways in a cylinder head for communicating coolant between the engine block 10 and the cylinder head. Likewise, a plurality of lubricant passageways 26 may open at the top deck 20, such as to align with related lubricant passageways in a cylinder head for communicating lubricant between the engine block 10 and the cylinder head.

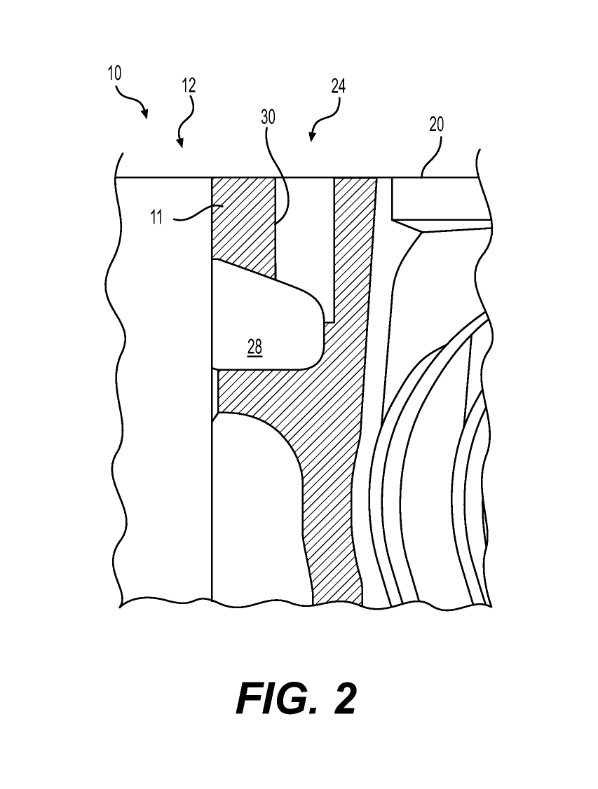

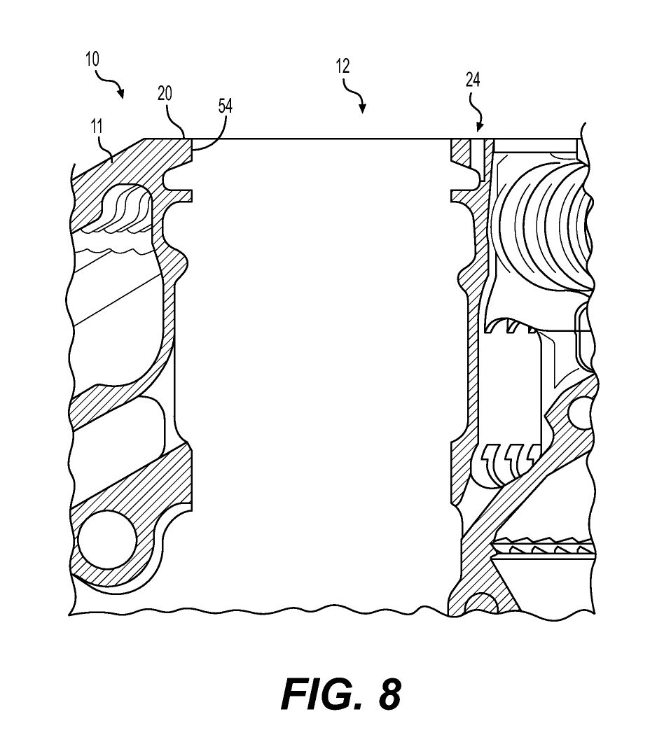

Thus, the cylinders 12, mounting bores 22, coolant passageways 24, and lubricant passageways 26 are all passageways in the engine block 10 that open at the top decks 20. Over time and with use, such passageways may become worn or eroded, or may otherwise be in need of repair. The description now turns to methods of remanufacturing the engine block 10, such as to repair these passageways. Exemplary descriptions are provided in association with a coolant passageway 24 (FIGS. 2-7) and a cylinder 12 (FIGS. 8-12), but it will be evident that these descriptions are generally applicable to all the passageways that open at the top decks 20.

Referring next to FIG. 2, additional details of one of the coolant passageways 24 are shown. The coolant passageway 24 extends downwardly from the top deck 20 into the engine block 10. In the embodiment shown, the coolant passageway 24 extends generally perpendicular to the top deck 20, and connects with a coolant channel 28 that generally surrounds the cylinder 12 below the top deck 20. The coolant passageway 24 and the coolant channel 28 are connected with each other so as to allow coolant to flow between them.

As shown in FIG. 2, the coolant passageway 24 may be defined by a wall surface 30 of the body 11 that is substantially straight and that extends between the top deck 20 and the coolant channel 28.

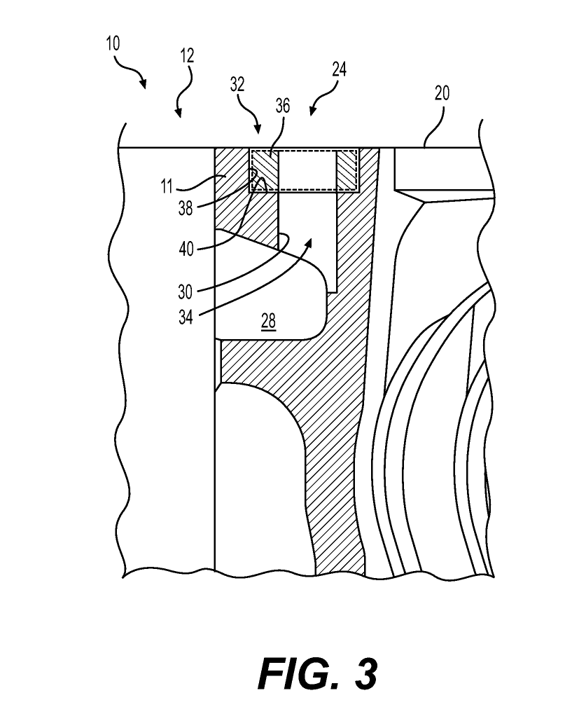

Alternatively, and as shown in FIG. 3, the coolant passageway 24 may be partially defined by a counterbore 32 and a main bore 34 of the body 11. The counterbore 32 opens at the top deck 20 and the main bore 34 extends downwardly from the counterbore 32. For example, the counterbore 32 may have been formed in the engine block 10 as part of an earlier process of remanufacturing the engine block 10, whereby an insert 36 (shown in dashed lines in FIG. 3) is positioned in the counterbore 32. If such an insert 36 is present in the engine block 10, it is removed as part of this method.

If the engine block 10 does not yet include the counterbore 32, the engine block 10 is machined to form it.

The counterbore 32 is defined by a side surface 38 and a base surface 40. The side surface 38 extends downwardly from the top deck 20, and the base surface 40 extends inwardly from the side surface 38 below the top deck 20. The base surface 40 intersects with the wall surface 30 generally inward of the side surface 38. The counterbore 32 and the main bore 34 may be generally coaxial with each other, as shown. The main bore 34 is generally defined by the wall surface 30 between the counterbore 32 and the coolant channel 28.

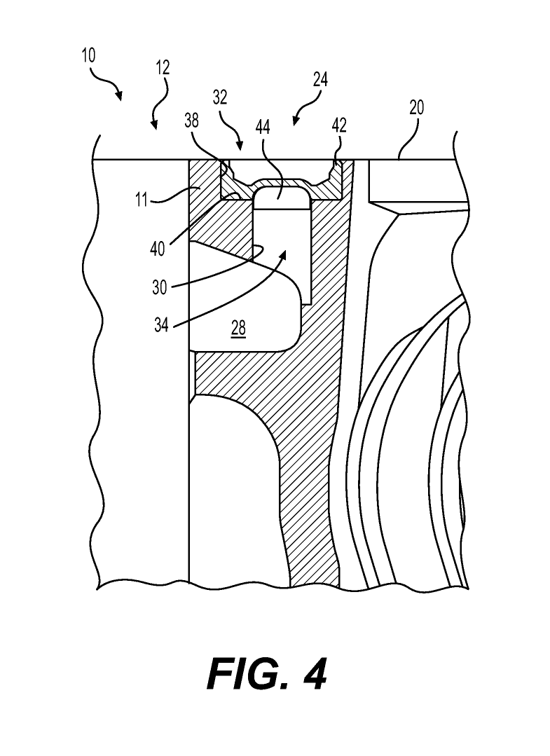

Referring next to FIG. 4, a solid powder metal is sprayed by a gas dynamic cold spray method onto the body 11 to form a fill member 42 that is adhered with the body 11. In particular, the solid powder metal is sprayed onto the side surface 38 and the base surface 40, and is adhered to those surfaces. As used in this disclosure, the term “gas dynamic cold spray method” refers to a coating deposition method whereby solid powder material is delivered by a gas jet (sprayed) into impacting relationship with a substrate. Upon impact, the solid powder material adheres with the substrate and/or other solid powder material that is already adhered with the substrate, thereby accumulating to form a metal coating. In the gas dynamic cold spray method, the solid powder material is not melted as it is sprayed.

The solid powder metal that is sprayed to form the fill member 42 may include stainless steel, such as 410 stainless steel. The solid powder metal that is sprayed to form the fill member 42 may also include a nickel aluminum material. The solid powder metal may be sprayed according to the gas dynamic cold spray method under any appropriate process parameters.

Optionally, and as shown in FIG. 4, a mask member 44 may be inserted into the coolant passageway 24 before the solid powder metal is sprayed to form the fill member 42. The mask member 44 may be in the form of a plug that is inserted into the main bore 34 to prevent the solid powder metal from entering the main bore 34. As shown, the mask member 44 is positioned generally inside the wall surface 30 and below the top deck 20. Thereby, the fill member 42 may be formed generally over the mask member 44.

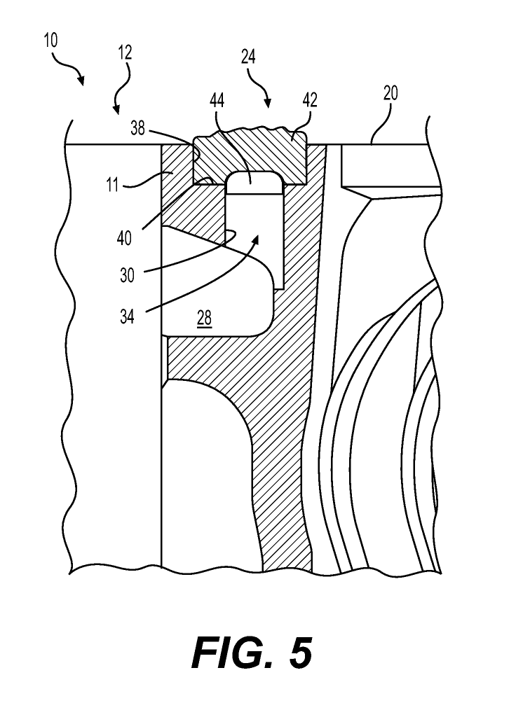

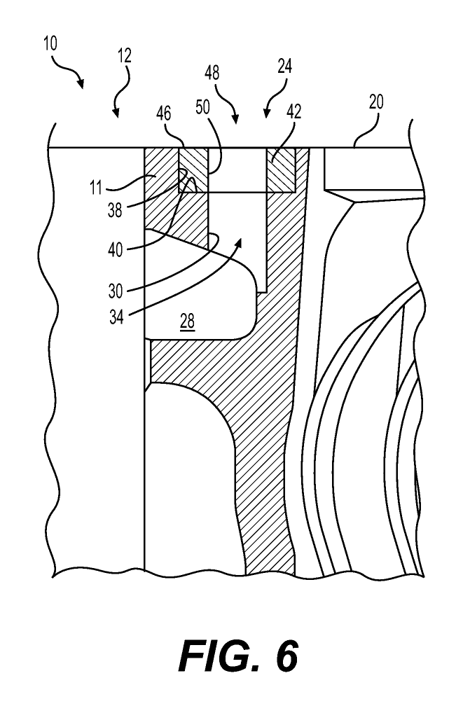

Referring next to FIG. 5, the solid powder metal may be sprayed such that the fill member 42 is built up where a portion of it extends above the top deck 20. The fill member 42 may subsequently be machined to remove this portion, as shown in FIG. 6, so as to bring an upper surface 46 of the fill member 42 into general alignment with the top deck 20. The upper surface 46 of the fill member 42 is generally opposite the base surface 40 of the counterbore 32.

The fill member 42 may also be machined to form a remanufactured passageway 48, as also shown in FIG. 6. For example, the fill member 42 may be drilled in order to form the remanufactured passageway 48, which is defined by an inner surface 50 of the fill member 42. As shown, the inner surface 50 is generally opposite the side surface 38 of the counterbore 32, and extends down from the upper surface 46 and generally through the fill member 42.

The mask member 44 is removed, such as by machining, and the remanufactured passageway 48 is connected with the main bore 34 such that coolant can be communicated between them. Thereby, following these steps, the coolant passageway 24 becomes defined at least partially by the body 11 and the fill member 42, and in particular by the main bore 34 and the remanufactured passageway 48.

The fill member 42 may be machined to bring the inner surface 50 into general alignment with the wall surface 30, as shown.

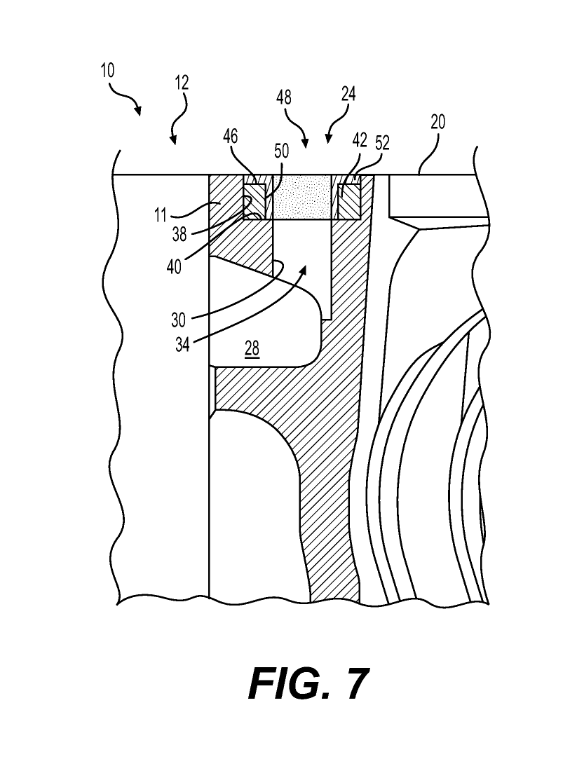

Referring next to FIG. 7, a surface treatment 52 may be applied to the fill member 42. In particular, the surface treatment 52 may be applied to the upper surface 46 and the inner surface 50 of the fill member 42. For example, the surface treatment 52 may be applied so as to completely cover the upper surface 46 and the inner surface 50.

Optionally, it may be desired to machine the fill member 42 such that the combination of the fill member 42 and the surface treatment 52 is generally aligned with the top deck 20 and/or the wall surface 30. For example, and as shown, the fill member 42 may be machined such that its upper surface 46 is positioned below the top deck 20, and such that its inner surface 50 is outside the wall surface 30. The surface treatment 52 may then be added such that the surface treatment 52 is generally aligned with the top deck 20 and the wall surface 30. The thickness or shape of the surface treatment 52 may be changed after it is applied to the fill member 42.

The surface treatment 52 may include a nickel aluminum material, and may be applied by a thermal spray method. As used in this disclosure, the term “thermal spray method” refers to a coating deposition method whereby melted coating material is sprayed onto a substrate.

Referring next to FIG. 8, additional details of one of the cylinders 12 are shown. As mentioned above, the cylinder 12 is configured to receive a piston. For example, the cylinder 12 may be configured to receive a cylinder liner (not shown) that receives the piston. The cylinder 12 extends downwardly from the top deck 20 into the engine block 10. In the embodiment shown, the cylinder 12 extends generally perpendicular to the top deck 20. The coolant channel 28 generally surrounds the cylinder 12 below the top deck 20 for providing coolant to carry heat away from the area of the cylinder 12.

As shown in FIG. 8, the cylinder 12 may be partially defined in the vicinity of the top deck 20 by a wall surface 54 of the body 11 that is substantially straight and that extends downwardly from the top deck 20.

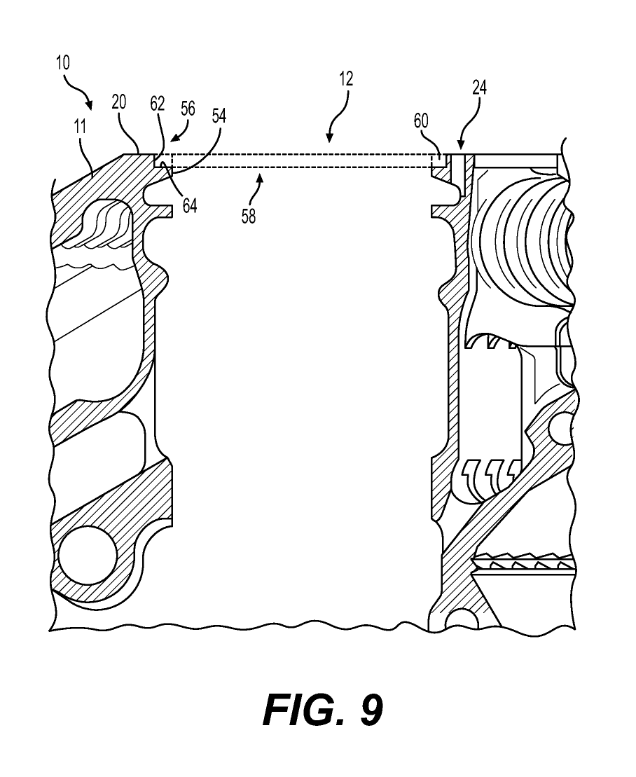

Alternatively, and as shown in FIG. 9, the cylinder 12 may be partially defined by a counterbore 56 and a main bore 58 of the body 11. The counterbore 56 opens at the top deck 20 and the main bore 58 extends downwardly from the counterbore 56. For example, the engine block 10 in its original condition may include the counterbore 56. Also, the counterbore 56 may have been formed in the engine block 10 as part of an earlier process of remanufacturing the engine block 10, whereby an insert 60 (shown in dashed lines in FIG. 9) is positioned in the counterbore 56. If such an insert 60 is present in the engine block 10, it is removed as part of this method.

If the engine block 10 does not yet include the counterbore 56, the engine block 10 is machined to form it.

In any event, the counterbore 56 is defined by a side surface 62 and a base surface 64. The side surface 62 extends downwardly from the top deck 20, and the base surface 64 extends inwardly from the side surface 62 below the top deck 20. The base surface 64 intersects with the wall surface 54 generally inward of the side surface 62. The counterbore 56 and the main bore 58 may be generally coaxial with each other, as shown. The main bore 58 is generally defined by the wall surface 54 below the counterbore 56. The cylinder 12 may also be defined by additional structural features below the main bore 58.

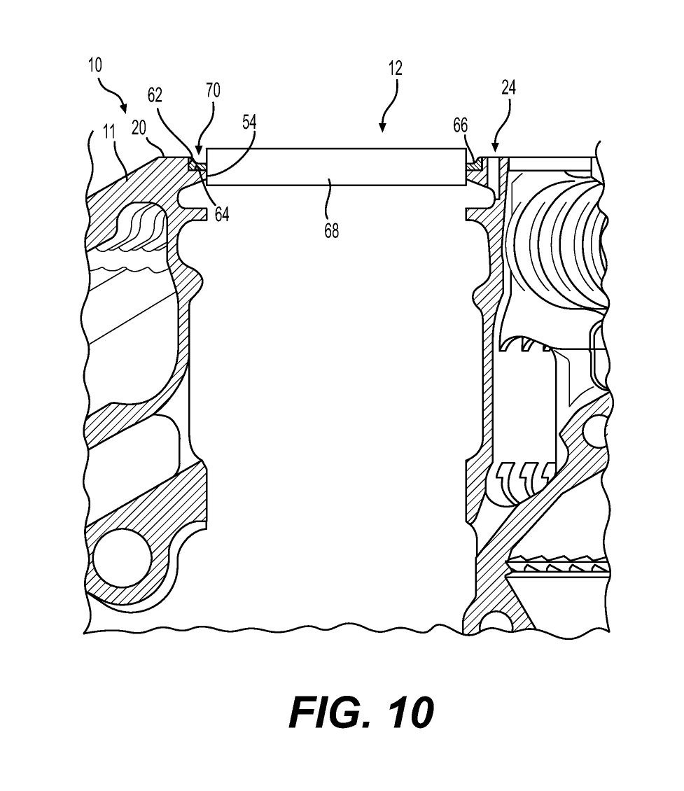

Referring next to FIG. 10, a solid powder metal is sprayed by a gas dynamic cold spray method onto the body 11 to form a fill member 66 that is adhered with the body 11. In particular, the solid powder metal is sprayed onto the side surface 62 and the base surface 64, and is adhered to those surfaces.

The solid powder metal that is sprayed to form the fill member 66 may include stainless steel, such as 410 stainless steel. The solid powder metal that is sprayed to form the fill member 66 may also include a nickel aluminum material. The solid powder metal may be sprayed according to the gas dynamic cold spray method under any appropriate process parameters.

Referring next to FIG. 10, a mask member 68 may be inserted into the cylinder 12 before the solid powder metal is sprayed to form the fill member 66. The mask member 68 may be in the form of a plug that is inserted into the main bore 58 to prevent the solid powder metal from entering the main bore 58. The fill member 66 may be formed between the mask member 68 and the engine block 10. As shown, the mask member 68 extends above the top deck 20. The mask member 68 thereby defines an annular channel 70 between the mask member 68 and the engine block 10, and the fill member 66 may be formed in a ring shape in the annular channel 70.

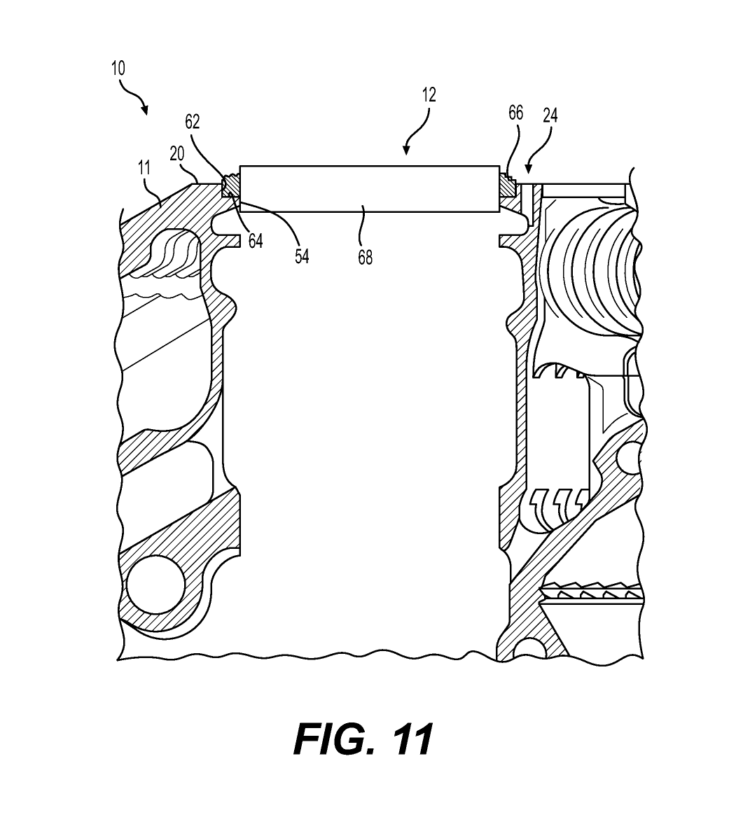

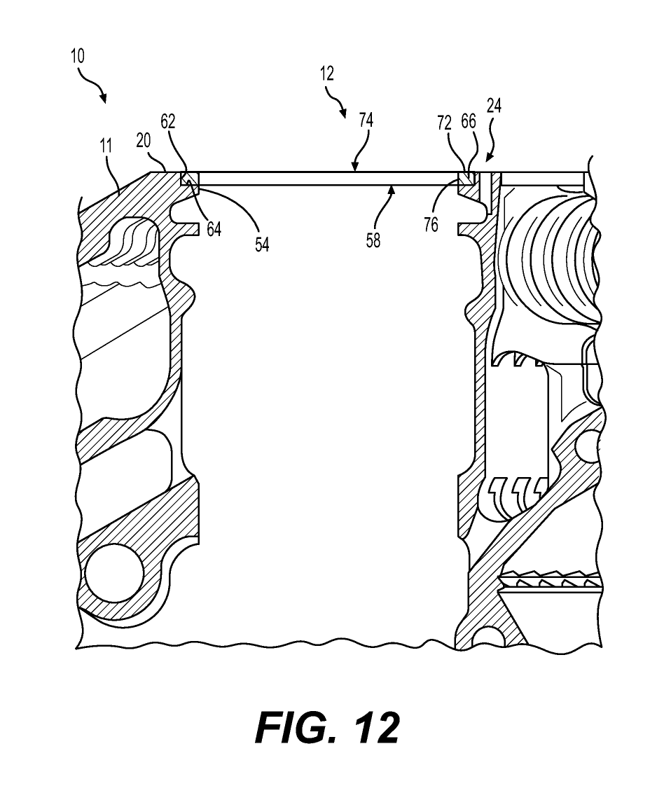

Referring next to FIG. 11, the solid powder metal may be sprayed such that the fill member 66 is built up where a portion of it extends above the top deck 20. The fill member 66 may subsequently be machined to remove this portion, as shown in FIG. 12, so as to bring an upper surface 72 of the fill member 66 into general alignment with the top deck 20. The upper surface 72 of the fill member 66 is generally opposite the base surface 64 of the counterbore 56.

The fill member 66 may also be machined to form a remanufactured passageway 74, as also shown in FIG. 12. For example, the fill member 66 may be drilled in order to form the remanufactured passageway 74, which is defined by an inner surface 76 of the fill member 66. As shown, the inner surface 76 is generally opposite the side surface 62 of the counterbore 56, and extends down from the upper surface 72 and generally through the fill member 66.

The mask member 68 is removed, such as by machining. Thereby, the remanufactured passageway 74 is connected with the main bore 58 such that coolant can be communicated between them. Thereby, following these steps, the cylinder 12 becomes defined at least partially by the body 11 and the fill member 66, and in particular by the main bore 58 and the remanufactured passageway 74.

The fill member 66 may be machined to bring the inner surface 76 into general alignment with the wall surface 54, as shown.

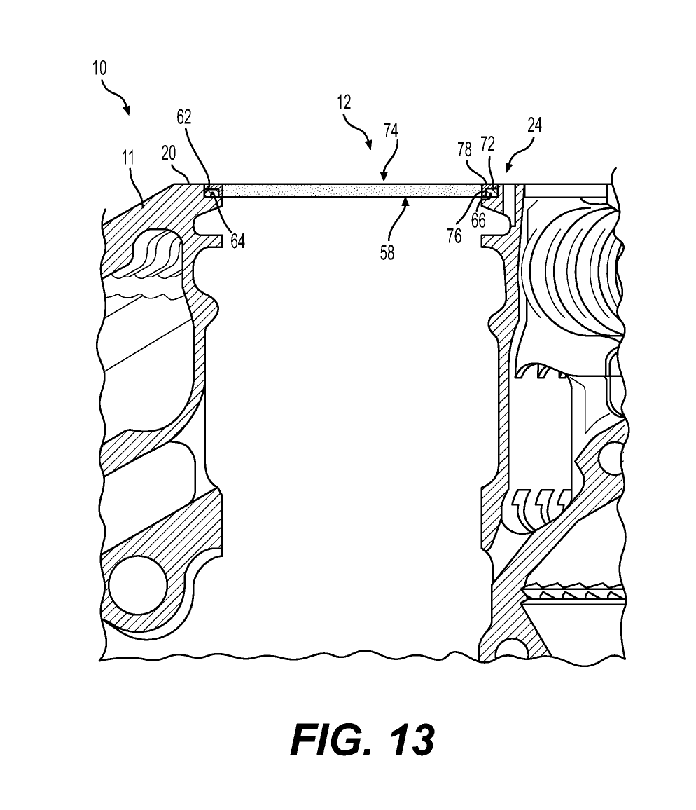

Referring next to FIG. 13, a surface treatment 78 may be applied to the fill member 66. In particular, the surface treatment 78 may be applied to the upper surface 72 and the inner surface 76 of the fill member 66. For example, the surface treatment 78 may be applied so as to completely cover the upper surface 72 and the inner surface 76.

Optionally, it may be desired to form the fill member 66 such that the combination of the fill member 66 and the surface treatment 78 is generally aligned with the top deck 20 and/or the wall surface 54. For example, and as shown, the fill member 66 may be machined such that its upper surface 72 is positioned below the top deck 20, and such that its inner surface 76 is outside the wall surface 54. The configuration of the mask member 68 may be chosen such that the inner surface 76 is formed outside of the wall surface 54. The surface treatment 78 may then be added such that the surface treatment 78 is generally aligned with the top deck 20 and the wall surface 54. The thickness or shape of the surface treatment 78 may be changed after it is applied to the fill member 66.

The surface treatment 78 may include a nickel aluminum material, and may be applied by a thermal spray method.

### INDUSTRIAL APPLICABILITY

Methods were described above for remanufacturing the engine block 10. In particular, steps were described in association with repairing passageways that open at the top deck 20 of the engine block 10. While the examples described herein related to the coolant passageways 24 and the cylinders 12, those method steps are also generally applicable to other passageways that open at the top deck 20, including the mounting bores 22 and the lubricant passageways 26.

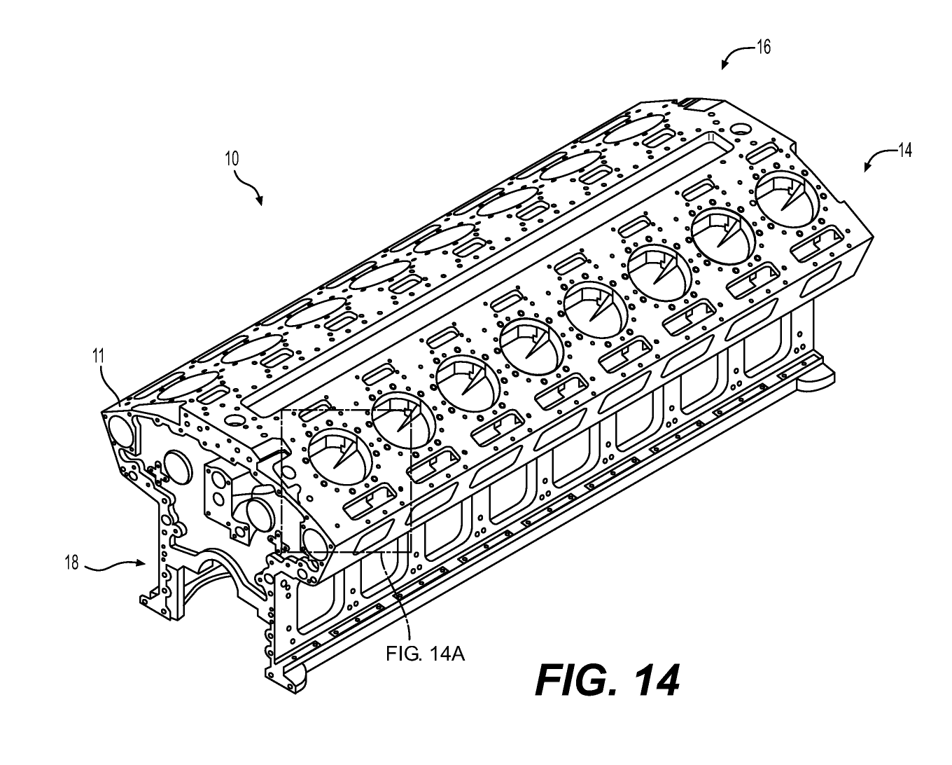

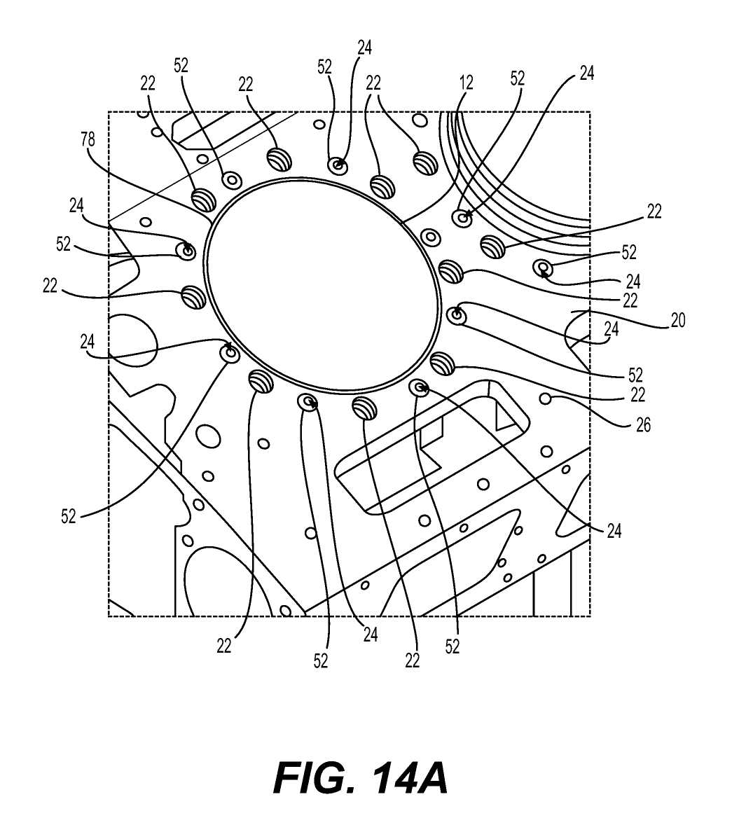

Referring next to FIGS. 14 and 14A, the engine block 10 is shown after having been remanufactured according to the method steps described above. Again, the engine block 10 includes a body 11 that is formed of engine block material, and has first and second cylinder banks 14, 16. Each of the cylinder banks 14, 16 includes a top deck 20. Several passageways (12, 22, 24, 26) open at each of the top decks 20. To repair one of the passageways, a fill member 42, 66 is deposited onto the body 11 of the engine block 10 by a gas dynamic cold spray method. As explained above, the fill member 42, 66 represents the accumulation of the solid powder metal. The passageway thereby becomes at least partially defined by the body 11 and the fill member 42, 66. A surface treatment 52, 78 may be applied to the fill member 42, 66. In particular, the surface treatment 52, 78 may include a nickel aluminum material that is applied to the upper surface 46, 72 and the inner surface 50, 76 of the fill member 42, 66.

What is claimed is:

1. A method of remanufacturing an engine block having a top deck and a passageway that opens at the top deck, the passageway being partially defined in the engine block by a counterbore having a side surface that extends downwardly from the top deck and a base surface that extends inwardly from the side surface below the top deck, the method comprising:
spraying solid powder metal onto the side surface and the base surface by a gas dynamic cold spray method so as to form a fill member adhered with the side surface and the base surface.

2. The method of claim 1, wherein a portion of the fill member extends above the top deck, and further comprising:
machining the fill member to remove the portion above the top deck.

3. The method of claim 1, further comprising:
machining the fill member to form a remanufactured passageway.

4. The method of claim 1, wherein the passageway is one of: a cylinder, a coolant passageway, a lubricant passageway, and a mounting bore.

5. The method of claim 1, further comprising:
before spraying solid powder metal, machining the engine block to form the counterbore.

6. The method of claim 1, further comprising:
before spraying solid powder metal, inserting a mask member into the passageway, and
after spraying solid powder metal, removing the mask member.

7. The method of claim 6, wherein the fill member is formed in a ring shape between the mask member and the engine block.

8. The method of claim 1, wherein the passageway is further partially defined in the engine block by a main bore that extends downwardly from the counterbore, and further comprising:
preventing solid powder metal from entering the main bore.

9. The method of claim 1, wherein the engine block further includes an insert positioned in the counterbore, and further comprising:
before spraying solid powder metal, removing the insert.

10. The method of claim 1, further comprising:
applying a surface treatment to the fill member.

11. The method of claim 8, wherein the fill member includes an inner surface generally opposite the side surface, and an upper surface generally opposite the base surface, and wherein applying a surface treatment includes applying a nickel aluminum material to the inner surface and the upper surface by a thermal spray method.

12. The method of claim 1, wherein the solid powder metal includes stainless steel or nickel aluminum material.

13. A method of remanufacturing an engine block having a top deck and a cylinder that opens at the top deck, the cylinder being partially defined by a counterbore having a side surface that extends downwardly from the top deck and a base surface that extends inwardly from the side surface below the top deck, the method comprising:
inserting a mask member into the cylinder,
spraying solid powder metal onto the side surface and the base surface by a gas dynamic cold spray method so as to form a fill member between the engine block and the mask member, and
removing the mask member.

14. The method of claim 13, wherein a portion of the fill member extends above the top deck, and further comprising:
machining the fill member to remove the portion above the top deck.

15. The method of claim 13, wherein the engine block further includes an insert positioned in the counterbore, and further comprising:
before spraying solid powder metal, removing the insert.

16. The method of claim 13, further comprising:
applying a surface treatment to the fill member.

17. The method of claim 16, wherein the fill member includes an inner surface generally opposite the side surface, and an upper surface generally opposite the base surface, and wherein applying a surface treatment includes covering the inner surface and the upper surface with a nickel aluminum material applied by a thermal spray method.

18. A remanufactured engine block, comprising:
a body including a top deck, the body being formed of engine block material,
a passageway that opens at the top deck, and
a fill member including accumulated solid powder metal deposited onto the body by a gas dynamic cold spray method,
the passageway being at least partially defined by the body and the fill member.

19. The remanufactured engine block of claim 18, further comprising: a surface treatment on the fill member.

20. The remanufactured engine block of claim 19, wherein the fill member includes an inner surface generally opposite the side surface, and an upper surface generally opposite the base surface, and wherein the surface treatment includes a nickel aluminum material on the inner surface and the upper surface.
